(19) United States
(12) Patent Application Publication
(10) Pub. No.: US 2026/0230374 A1
(43) Pub. Date: Aug. 6, 2026

(54) SYSTEM AND METHOD FOR AUTOMATICALLY DETERMINING AN ORDER OF TROUBLESHOOTING STEPS FOR A COMMUNICATION NETWORK

(71) Applicant: BOOST SUBSCRIBERCO L.L.C., Englewood, CO (US)

(72) Inventors: Alexander Nelson, Parker, CO (US); Tanya Mazur, Littleton, CO (US)

(21) Appl. No.: 19/047,462

(22) Filed: Feb. 6, 2025

(51) Int. Cl. H04L 41/0631; G06F 9/451

(52) U.S. Cl. CPC H04L 41/0631; G06F 9/451

(57) ABSTRACT

A system for automatically determining an order of troubleshooting steps for a communication network includes a memory that stored one or more computer readable media that includes instructions and one or more processor devices configured to execute the instructions of the computer readable media to identify a set of tagged steps for a troubleshooting flow at a predetermined time, retrieve resolution data for each tagged step from a database, the resolution data from a predetermined time interval, determine an order for the tagged steps in the set of tagged steps based on the resolution data for each tagged step, and store the order for the tagged steps in data storage.

### BACKGROUND

Communication networks that transport digital data and telephone calls are becoming increasingly sophisticated. Currently, fifth generation (5G) broadband cellular networks are being deployed around the world. These 5G networks use emerging technologies to support data and voice communications with millions, if not billions, of mobile phones, computers and other devices. 5G technologies are capable of supplying much greater bandwidths than was previously available.

### SUMMARY

In accordance with an embodiment, a system for automatically determining an order of troubleshooting steps for a communication network includes a memory that stored one or more computer readable media that includes instructions and one or more processor devices configured to execute the instructions of the computer readable media to identify a set of tagged steps for a troubleshooting flow at a predetermined time, retrieve resolution data for each tagged step from a database, the resolution data from a predetermined time interval, determine an order for the tagged steps in the set of tagged steps based on the resolution data for each tagged step, and store the order for the tagged steps in data storage.

In accordance with another embodiment, a method for automatically determining an order of troubleshooting steps for a communication network includes identifying, using a processor device, a set of tagged steps for a troubleshooting flow at a predetermined time, retrieving, using the processor device, resolution data for each tagged step from a database, the resolution data from a predetermined time interval, determining, using the processor device, an order for the tagged steps in the set of tagged steps based on the resolution data for each tagged step, and storing the order for the tagged steps in data storage.

In accordance with yet another embodiment, a non-transitory, computer-readable medium storing instructions that, when executed by a processor perform a set of functions for automatically determining an order of troubleshooting steps for a communication network. The set of functions include identifying, using a processor device, a set of tagged steps for a troubleshooting flow at a predetermined time, retrieving, using the processor device, resolution data for each tagged step from a database, the resolution data from a predetermined time interval, determining, using the processor device, an order for the tagged steps in the set of tagged steps based on the resolution data for each tagged step, and storing the order for the tagged steps in data storage.

### BRIEF DESCRIPTION OF THE DRAWINGS

The present disclosure will hereafter be described with reference to the accompanying drawings, wherein like reference numerals denote like elements.

FIG. 1 is a schematic block diagram of an example communication network in accordance with an embodiment;

FIG. 2 is a schematic block diagram of a system for automatically determining an order of troubleshooting steps for a communication network in accordance with an embodiment;

FIG. 3 illustrates a method for automatically determining an order of troubleshooting steps for a communication network in accordance with an embodiment;

FIG. 4 illustrates a method for generating user interface(s) for troubleshooting for a communication network in accordance with an embodiment;

FIGS. 5A-5C illustrate an example graphical user interface for troubleshooting for a communication network in accordance with an embodiment; and

FIG. 6 is a schematic block diagram of an example computer system in accordance with an embodiment.

### DETAILED DESCRIPTION

A plurality of hardware and software-based devices, as well as a plurality of different structural components can be used to implement the disclosed technology. In addition, examples of the disclosed technology can include hardware, software, and electronic components or modules that, for purposes of discussion, can be illustrated and described as if the majority of the components were implemented solely in hardware. However, in at least one example, the electronic based aspects of the disclosed technology can be implemented in software (for example, stored on non-transitory computer-readable medium) executable by one or more electronic processors. Although certain drawings illustrate hardware and software located within particular devices, these depictions are for illustrative purposes only. In some examples, the illustrated components can be combined or divided into separate software, firmware, hardware, or combinations thereof. As one example, instead of being located within and performed by a single electronic processor, logic and processing can be distributed among multiple electronic processors. Regardless of how they are combined or divided, hardware and software components can be located on the same computer device or can be distributed among different computing devices connected by one or more networks or other suitable communication links.

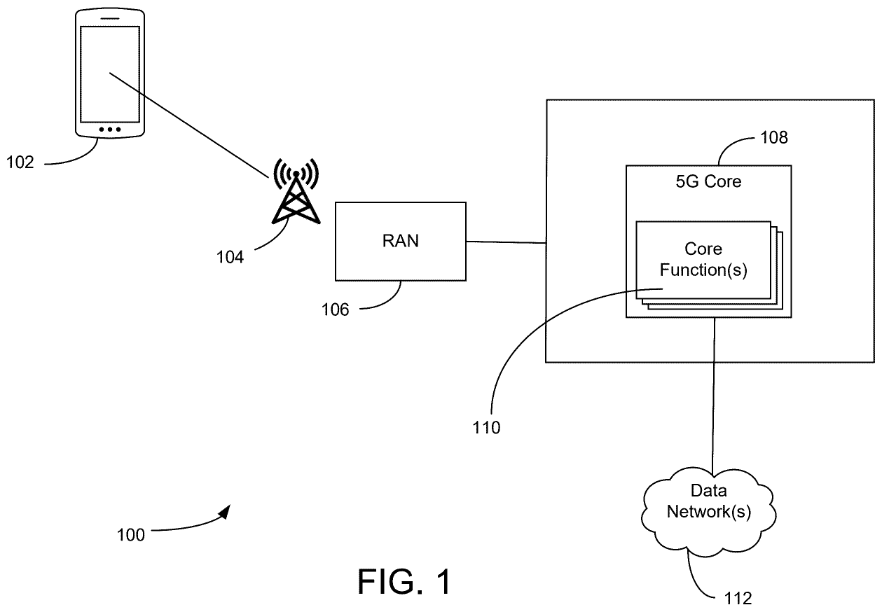

FIG. 1 is a schematic block diagram of an example communication network in accordance with an embodiment. The communication network 100 can include a user equipment (UE) device 102, a radio access network (RAN) 106, and a 5G core 108. The RAN 106 and 5G core 108 can enable the UE device 102 to, for example, communicate with other UE devices and to communicate with one or more external data networks (DNs) 112 (e.g., the Internet or a private corporate network) using the RAN 106 and 5G core 108. For example, if the external data network 112 is the Internet, the RAN 106 and 5G core 108 can allow the UE device 102 to send and receive data via the Internet. While FIG. 1 illustrates various components of communication network 100, other embodiments of communication network 100 can vary the arrangement, communication paths, and specific components of communication network 100. In some embodiments, the communication network 100 can include fewer, additional, or different components in different configurations than illustrated in FIG. 1. For example, in some embodiments, the communication network 100 may include additional or different UE devices 102.

The communication network 100 may be used to facilitate multiple types of communication sessions, such as, for example, voice calls, video calls, messaging, data transmission, and/or other types of communications. In some embodiments, the communication network 100 can be configured to implement IP multimedia services or subsystems (IMS) for delivering multimedia communication services such as, for example, voice, video, and text messaging over IP networks. The communication network 100 may represent a portion of a wireless network built around 5G (fifth generation) standards promulgated by standards setting organizations under the umbrella of the Third Generation Partnership Project (3GPP). Accordingly, in some configurations, the communication network 100 may be a 5G network, such as, for example, a 5G cellular network. Such 5G networks, including the communication network 100, may comply with industry standards, such as, for example, the Open Radio Access Network (Open RAN or O-RAN) standard that describes interactions between the network and user equipment (e.g., mobile phones and the like). The O-RAN model follows a virtualized model for a 5G wireless architecture in which 5G base stations (gNBs) are implemented using separate centralized units (CUs), distributed units (DUs), and radio units (RUs). In some configurations, O-RAN CUs and DUs may be implemented using software modules executed by distributed (e.g., cloud) computing hardware. Virtualization allows for various other components of the cellular network, such as cellular network core functions, to be implemented as code that is executed using general-purpose computer resources. Such general purpose computing resources can be part of a public cloud-computing platform that provides virtual private clouds (VPCs) for multiple clients. On a hybrid cellular network, RAN components of the cellular network are in communication with components of the cellular network executed on a public cloud computing platform such as Amazon Web Services (AWS).

In some configurations, the communication network 100 may be a standalone (SA) network (e.g., a 5G SA network) that utilizes 5G cells for both signaling and information transfer via a 5G packet core architecture. In other configurations, the communication network 100 may be a non-standalone (NSA) network that depends on another network, such as, for example, a control plane of a fourth generation (4G) long-term evolution (LTE) network.

As mentioned, in some embodiments, the UE device 102 can transmit data from one or more applications on the UE device 102 to an external data network (DN) 112, for example, the Internet, via the communication network 100. While FIG. 1 illustrates one UE device 102, in some embodiments, it should be understood that the communication network 100 can support a plurality of UE devices 102. UE device 102 can be various forms of wireless devices that are capable of communication according to the radio access technology (RAT) of the communication network 100 (e.g., a 5G new radio (NR) network). For example, in some embodiments, the UE device 102 can be a smartphone, a wireless modem, a cellular phone, a laptop computer, a wireless access point (AP), etc.

After the UE device 102 has established a connection or session with the RAN 106, the communication network 100 can provide data (e.g., data packets) to the UE device 102 and can receive data from the UE device 102. In some embodiments, the data can include, for example, voice data for a phone call, data provided by a web server to the UE device 102, data provided by the UE device 102 to a Web server, or other types of data commonly exchanged on communication networks. For example, after the UE device 102 has established a connection or session with the RAN 106, a user of the UE device 102 may select to stream a video on an application of the UE device 102 via the Internet (e.g., data network 112). The video stream can be provided to the UE device 102 on data packets.

The UE device 102 can communicate with the RAN 106 in various ways, such as, for example, via a radio transceiver 104, which may also be referred to as a radio unit (RU) in the O-RAN architecture. The RAN 106 may be or include a disaggregated RAN (referred to as an Open RAN or O-RAN) which can include hierarchy (e.g., tree structure) of RAN functions. In such examples, the RAN 106 may include one or more CUs and one or more DUs. For example, each of multiple CUs may be coupled with multiple DU, and each DU may be coupled with multiple RUs (e.g., the radio transceiver 104). As such, each UE device 102 can communicate with backhaul network infrastructure (e.g., a 5G Core 108) according to an assigned communication path through a particular RU, DU, and CU. An RU (e.g., the radio transceiver 104) in combination with a DU and CU may be referred to as a gNodeB (gNB) in the O-RAN architecture. Such a gNB may be a 3GPP 5G next generation base station that supports communications with the with the UE device 102. While FIG. 1 illustrates a single radio transceiver 104 and a single RAN 106, in practical implementations the communication network 100 may include any number of radio transceivers 104 and/or any number of RAN 106.

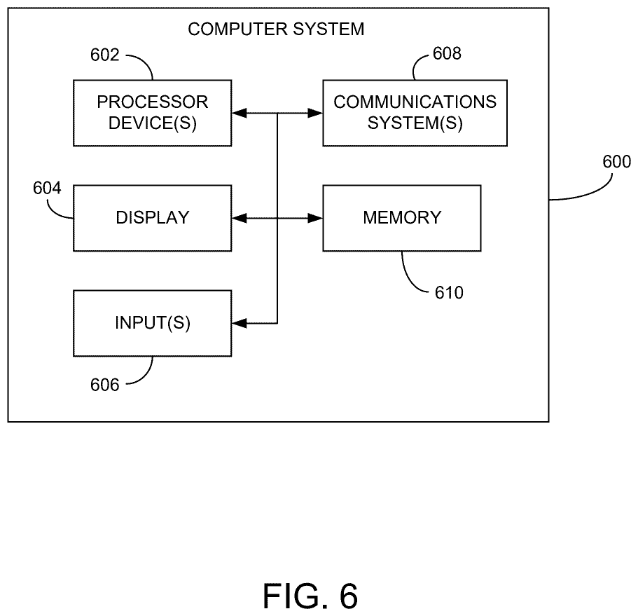

The 5G Core 108 may include one or more core functions 110. Each core function 110 can be a network function (NF) that provides a utility or service specific to the 5G core 108, for example, core functions of the communication network 100. In some embodiments, for example, different NFs may provide different utility to the communication network 100. In some embodiments, the 5G core 108 including the core functions 110 can reside on a cloud computing platform. For example, in some embodiments, the communication network (e.g., communication network 100), or portion thereof, in which the 5G core 108 is implemented may be disaggregated, such that, for example, NFs may be developed or operated by multiple vendors or operators. In some embodiments, an NF may be virtualized. An NF may be virtualized by implementing the NF in a cloud-native architecture. Accordingly, in some embodiments, an NF may be a cloud-native NF (CNF). A CNF may refer to a service (or utility) that performs network duties in software (e.g., as opposed to purpose-built hardware). Examples of various core functions 110 include, but are not limited to a Network Slice Selection Function (NSSF), a Network Exposure Function (NEF), a Network Repository Function (NRF), a Policy Control Function (PCF), a Unified Data Management (UDM) function, an Authentication Server Function (AUSF), an Access and Mobility Management Function (AMF), a Session Management Function (SMF), and a User Plane Function (UPF). In some embodiments, the RAN 106 and the 5G core 108 (including core functions 110) may be implemented on a computer system (e.g., computer system 600 discussed below with respect to FIG. 6) such as a server or the functionality of the RAN 106, the 5G core 109 and core functions 110 may be distributed among multiple servers or devices (e.g., as part of a cloud service or cloud-computing environment). In some embodiments, the 5G core 108 can be physically distributed across data centers or located at a central national data center (NDC) (e.g., the 5G core can logically reside as part of an NDC, for example, in a region-based network topology (discussed further below). Within an NDC, multiple regional data centers (RDCs) can be logically present. In some embodiments, each of such one or more regional data centers may execute core functions 110 for a different geographic region or a group of RAN components.

As mentioned, in some embodiments, the communication network 100 can be configured according to a region-based topology. For example, the communication network 100 may be implemented using a cloud computing platform that is logically and physically divided up into various different cloud computing regions (e.g., AWS regions). The cloud computing regions may be based on geographical location of the gNbs; for example, the communication network 100 for a given nation may be divided into a number of geographical regions. Each of the cloud computing regions can be isolated from other cloud computing regions to help provide fault tolerance, fail-over load-balancing, and/or stability and each of the cloud computing regions can be composed of multiple availability zones (AZs) or markets, each of which can be a separate data center located in general proximity to each other (e.g., within 100 miles). For example, one cloud computing region may have its data centers and hardware located in the northeast of the United States while another cloud computing region may have its data centers and hardware located in California. Each of the availability zones may be a discrete data center or group of data centers that allows for redundancy, thereby to provide fail-over protection from other availability zones within the same cloud computing region. For example, when a particular data center of an availability zone experiences an outage, another data center of the availability zone or separate availability zone within the same cloud computing region can continue functioning and providing service.

The communication network 100 can be associated with and operated by a communication service provider (CSP) or carrier. In a communication network (e.g., a cellular network) such as communication network 100, customers (or subscribers, or end users) may experience problems with the communication services provided by the CSP via the communication network and the associated consumer products (hardware and software) used to enable access to the communication services of the CSP. For example, a subscriber may have difficulty making or receiving phone calls or have dropped calls. A subscriber may contact the CSP, for example, by phone or over a web site associated with the CSP, to try to identify and resolve the issue. The CSP may provide an internal customer service application or tool to a customer service representative (or agent) of the CSP to guide the customer service agent through one or more troubleshooting flows to obtain information from the subscriber to identify and resolve the problem or issue. Each troubleshooting flow can include a plurality of troubleshooting steps, each commonly presented in the form of a question. The troubleshooting steps in each troubleshooting flow are predetermined by the CSP and typically presented in the same order to the customer service representative to walk through for each interaction with a subscriber. This can be inefficient, in particular when there is a specific event (e.g., a network failure in a particular geographic region) that has occurred and the customer service representative is required to walk through the same order for the troubleshooting steps in a troubleshooting flow. It can therefore take longer to get to the step that will identify the problem and provide a resolution.

The present disclosure describes a system and method for automatically determining an order of troubleshooting steps in a troubleshooting flow. In some embodiments, a troubleshooting module (e.g., an application or tool) can be configured to automatically generate an order for a set of troubleshooting steps in a troubleshooting flow based on resolution data associated with each troubleshooting step. In some embodiments, at a predetermined time, the troubleshooting module can be configured to identify a set of tagged troubleshooting steps (or tagged steps), for example, tagged steps that are associated with a troubleshooting flow. In some embodiments, the predetermined time can be, for example, one an hour, once a day, once a week, etc. In some embodiments, the predetermined time can be whenever a user (e.g., a customer service representative) starts a new session of the troubleshooting module for an interaction with a subscriber. Accordingly, the order of the tagged steps can be updated continuously. Resolution data for each tagged step in the set of tagged steps can be retrieved from a tagged step and resolution data database. In some embodiments, the resolution data can be retrieved for a predetermined time interval. For example, resolution data can be retrieved for the set of tagged steps for the prior 24 hour period, for the prior week, etc. An order for the tagged steps, e.g., the order in which each step is presented to a user of the troubleshooting module (e.g. a customer service representative of a CSP) to obtain information from a subscriber can be determined based on the resolution data for each tagged step. In some embodiments, the resolution data can be the number of times a tagged step was a resolution (e.g., the resolution volume) to the issue of the subscriber, for example, when the tagged step identifies a source or cause of the problem experienced by the subscriber. In some embodiments, the resolution data can be a resolution rate, for example, the percentage of times the tagged step was a resolution to the issue of the subscriber. In some embodiments, the tagged steps can be ordered from the tagged step with the highest number of resolutions or resolution rate to the tagged step with the lowest number of resolutions or resolution rate. The order can be stored in data storage or memory. As mentioned, the troubleshooting module can advantageously be configured to present each tagged step for a troubleshooting flow (e.g., using a user interface) to a user of the troubleshooting module (e.g. a customer service representative of a CSP) in the order determined based on the resolution data. Accordingly, the tagged step that results in the most resolutions can be presented first to the user to obtain information from the subscriber. By periodically or continuously updating the order for the tagged steps of the troubleshooting flows of a troubleshooting module, specific events or sources of issues (e.g., a network failure on a specific day) can be reflected in the order of the tagged steps so that the tagged step most likely to resolve an issue can be asked sooner in the troubleshooting flow than those steps less likely to resolve an issue. The disclosed system and method can advantageously reduce the overall time required to successfully troubleshoot (e.g., identify and resolve) the problem being experienced by a subscriber and enhance network management efficiency by swiftly identifying the source of an issue experienced by a subscriber. In addition, the disclosed system and method can improve the customer experience by improving the speed of resolution.

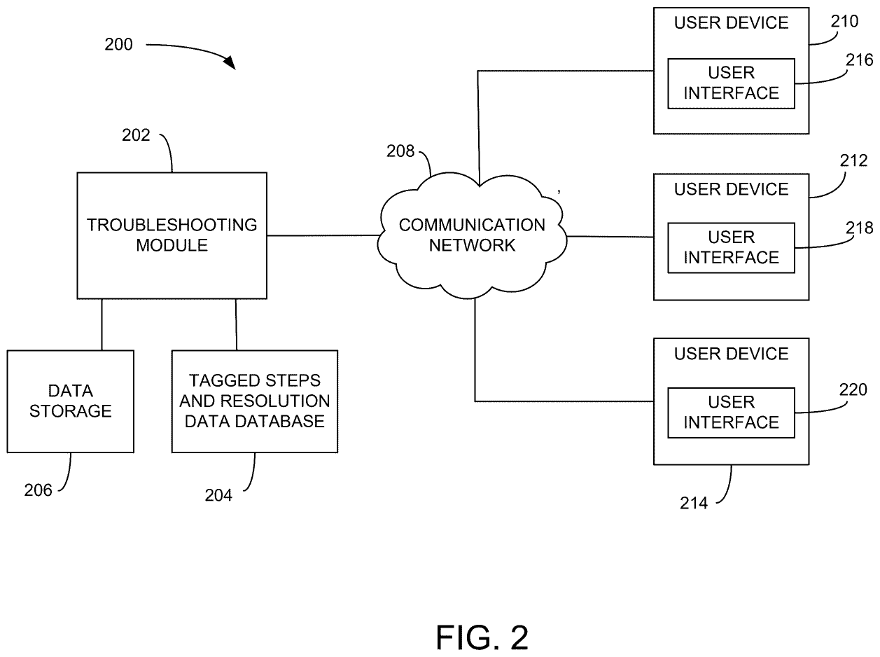

FIG. 2 is a block diagram of a system for automatically determining an order of troubleshooting steps for a communication network in accordance with an embodiment. The system 200 can include a troubleshooting module 202, a tagged steps and resolution data database 204, data storage (or memory) 206, a communication network 208, and one or more user devices 210, 212, and 214. In some embodiments, the system 200 can be associated with a CSP or carrier that provides communication services using a communication network such as, for example, communication network 100 shown in FIG. 1. The troubleshooting module 202 can be a customer service application or tool that can be utilized by users of the CSP to troubleshoot issues or problems experienced by subscribers with communication services provided by the CSP. In some embodiments, the troubleshooting module 202 can be configured to provide a plurality of troubleshooting flows that provide troubleshooting steps to guide the user to obtain information from the subscriber to identify and resolve the problem or issue. In some embodiments, the plurality of troubleshooting flows can include, for example, a general troubleshooting flow and one or more subject specific troubleshooting flows. Subject specific troubleshooting flows can be based on, for example, the type of problem (e.g., a dropped call, voice quality, can't make a call, can't exit an application, etc.), the type of UE device used by the subscriber, the type of service (e.g., voice services, data services, international or domestic services), consumer products or accessories, a type of error code, etc.,

In some embodiments, a troubleshooting flow can include a plurality of troubleshooting steps, each of which can be in the form of a question. The troubleshooting steps in a particular troubleshooting flow can, in some embodiments, include questions configured to gather general or clarifying information and in some cases, based on the answer, redirect the user to a different subject specific troubleshooting flow. As used herein, these general questions are referred to as untagged troubleshooting steps (or untagged steps). Examples of untagged steps include, but are not limited to, “Is the subscriber an employee of the CSP?”; “Is the subscriber calling about international services?”; or “Is the subscriber calling about an accessory?” The troubleshooting steps in a particular troubleshooting flow can also include a set of two or more questions that are tagged for automating ordering (referred to herein as tagged troubleshooting steps or tagged steps) and are eligible to be rearranged. In some embodiments, a troubleshooting flow may only include tagged steps. In some embodiments, a tagged step is a question with two options (e.g., “Yes” or “No”) where one of the options is a resolution (or solution), e.g., the answer identifies the source or cause of the problem experienced by the subscriber. In one example, a tagged step can be “Is the line active?” If the answer is “Yes,” the troubleshooting module 202 can move to the next troubleshooting step in the troubleshooting flow. If the answer is “No,” this is the resolution and the user can be provided with the next steps such as, for example, entering a customer service ticket for the subscriber so that an administrator for the CSP can take steps to address and fix the issue. In another example, a tagged step can be “Does power cycling the device resolve the issue?” A “Yes” answer provides a resolution. If the answer is “No,” the troubleshooting module 202 can move to the next troubleshooting step in the troubleshooting flow. In yet another example, a tagged step can be “Does switching to a different channel resolve the issue?” A “Yes” answer provides a resolution. If the answer is “No,” the troubleshooting module 202 can move to the next troubleshooting step in the troubleshooting flow. In some embodiments, the tagged steps or identifiers of the tagged steps for each troubleshooting flow can be stored in the tagged steps and resolution data database 204.

The troubleshooting module 202 can also be configured to store resolution data for each tagged question in the tagged steps and resolution data database 204. In some embodiments, each time a tagged step receives a response such as to be a resolution, the troubleshooting module 202 can be configured to store the resolution data in the tagged steps and resolution data database 204. As mentioned, in some embodiments, the resolution data for each tagged step can include the total number of resolutions for the tagged step (e.g., the number of times the tagged step was the resolution or solution to the issue of a subscriber). In some embodiments, the resolution data for each tagged step can include a date and time each resolution occurred. In some embodiments, the resolution data can include a resolution rate (or percentage) for the tagged step. In some embodiments, a tagged step can occur in more than one troubleshooting flow and the resolution data for the tagged step can be stored separately for each troubleshooting flow, e.g., the number of resolutions for a troubleshooting step that occurred during a first troubleshooting flow can be stored separately from the number of resolutions for the troubleshooting step that occurred during a second troubleshooting flow. In other words, the tagged step can have a unique resolution number for each troubleshooting flow in which it appears. In some embodiments, a tagged step may be included in a sub-flow that is used in more than one troubleshooting flow. In such embodiments, the total number of resolutions for the tagged step that occurred during any instance of the sub-flow in any troubleshooting flow can be stored for the tagged step.

The troubleshooting module 202 can advantageously be configured to determine an order (or ranking) for the set of tagged steps for each troubleshooting flow. In particular, at a predetermined time, the troubleshooting module 202 can be configured to determine an order (or update the order) for the tagged steps for each troubleshooting flow based on the resolution data for each tagged step for a predetermined time interval (or time frame). In some embodiments, the order of tagged steps for each troubleshooting flow can be determined, for example, once an hour, once a day, once a week, or continuously. In some embodiments, the troubleshooting module can retrieve resolution data for each tagged step from, for example, the previous 24 hours, the previous week, etc. In one example, the troubleshooting module 202 can be configured to determine (or update) the order of the tagged steps for at least one of the troubleshooting flows once a day (e.g., at 4 am) and utilize resolution data for each tagged step from the previous 24 hours. Accordingly, the determined order for the tagged steps can be utilized by the troubleshooting module until the next daily update at 4 am. In another example, the troubleshooting module 202 can be configured to update the order of the set of tagged steps for one or more of the troubleshooting flows continuously using resolution data for each tagged step from the predetermined time interval (e.g., 24 hours, one week, etc.). For example, the troubleshooting module 202 can be triggered to determine an order for the tagged steps each time a user starts a session with the troubleshooting module for a subscriber using resolution data for each tagged step from, for example, the previous 24 hours. In some embodiments, additional data, for example, an indication that there is a network outage, weather data or other data that may indicate conditions that impact network performance, can also be provided to the troubleshooting module 202 (e.g., from data storage 206). The additional data can be used to, for example, determine the order of tagged steps or determine the frequency of updates of the order of tagged steps (e.g., the predetermined time) or the predetermined time interval or time frame for the retrieved resolution data for each tagged step (e.g., previous 24 hours). Accordingly, the troubleshooting module 202 can be configured to determine an order of tagged steps based on a recent event that may cause a spike in problems for and contacts from subscribers.

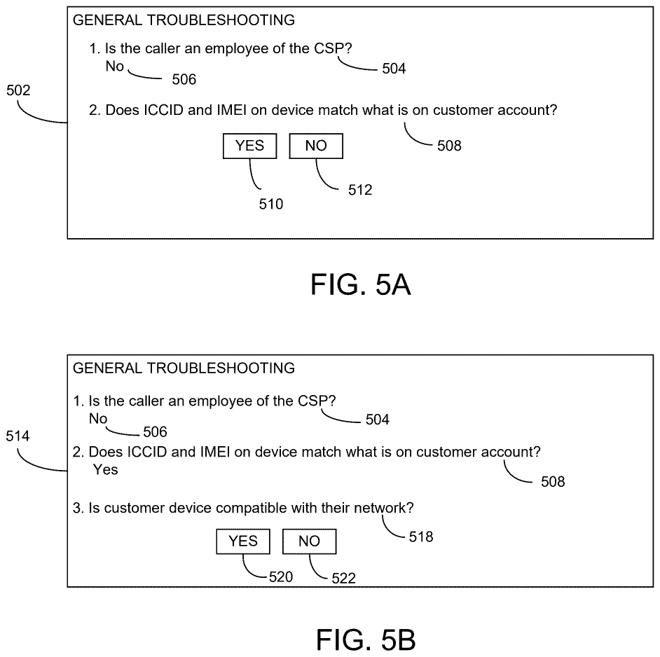

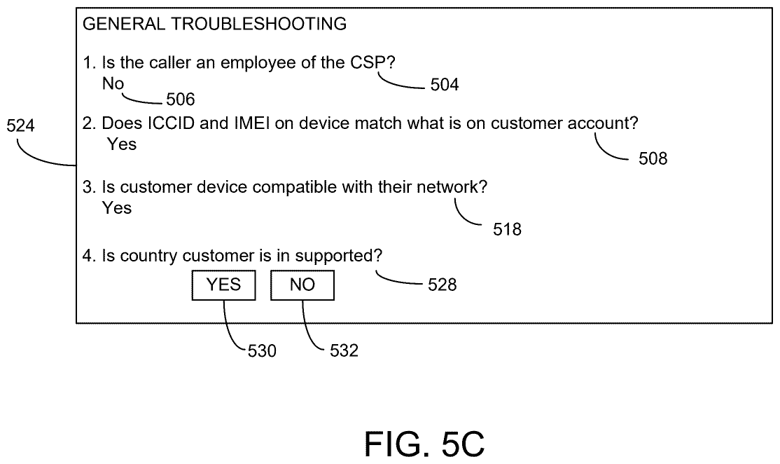

In some embodiments, the order of tagged steps can be, for example, from highest number of resolutions within the predetermined time interval to lowest number of resolutions within the predetermined time interval or highest resolution rate to lowest resolution rate. The determined order for the tagged steps for each troubleshooting flow can be stored in data storage 206. When a user (e.g., a customer service representative of the CSP) accesses the troubleshooting module 202 and initiates a session, the troubleshooting module 202 can be configured to identify an appropriate troubleshooting flow, for example, based on an input from the user. The troubleshooting module 202 can retrieve the order for the tagged steps for the troubleshooting flow from data storage 206 and provide the tagged steps to the user based on the order (e.g., from highest number of resolutions to lowest number of resolutions. For example, as discussed further below, the troubleshooting module can generate a graphical user interface (GUI) to be presented to the user, for example, using a display. Example GUIs are discussed below with respect to FIGS. 5A-5C. In some embodiments, the troubleshooting module 202, tagged steps and resolution database 204 and data storage 206 can be implemented on a computer system or server (e.g., computer system 600 discussed below with respect to FIG. 6).

As shown in FIG. 2, one or more users can access the troubleshooting module 202 using a user device 210, 212, 214 over a communication network 208. In some embodiments, user devices 210, 212, 214 can be a computer system such as, for example, computer system 600 discussed below with respect to FIG. 6). Each user device 210, 212, 214 can include a user interface 216, 218, 220, respectively. The user interfaces 216, 218, 220 can be used to allow a user (e.g., a customer service representative of the CSP) to interact with the troubleshooting module 202, for example, to provide inputs to the troubleshooting module 202 in response to the untagged and tagged steps provided by the troubleshooting module 202 for a troubleshooting flow. The user interface 216, 218, 220 (e.g. inputs of a computer system 600 shown in FIG. 6) can include any suitable input devices and/or sensors that can be used to receive the user input such as a keyboard, a mouse, a touch screen, a microphone, a graphical user interface (GUI), a voice user interface (VOI), mechanical switches, buttons, knobs, etc. The user interfaces 216, 218, 220 can also include a display that can be used to display, for example, the untagged steps and tagged steps for a troubleshooting flow, for example, using a graphical user interface generated by the troubleshooting module 202.

Communication network 208 can be any suitable communication network or combination of communication networks. For example, communication network 208 can include a Wi-Fi network (which can include one or more wireless routers, one or more switches, etc.), a peer-to-peer network (e.g., a Bluetooth network), a cellular network (e.g., a communication network 100 shown in FIG. 1), a wired network, etc. In some embodiments, communication network 208 can be a local area network (LAN), a wide area network (WAN), a public network (e.g., the Internet), a private or semi-private network (e.g., a corporate or university intranet), any other suitable type of network, or any suitable combination of networks.

While FIG. 2 illustrates various components of the system for automatically determining an order of troubleshooting steps for a communication network, other embodiments of the system can vary the arrangement, communication paths, and specific components of the system. In some embodiments, the system can include fewer, additional, or different components in different configurations than illustrated in FIG. 2.

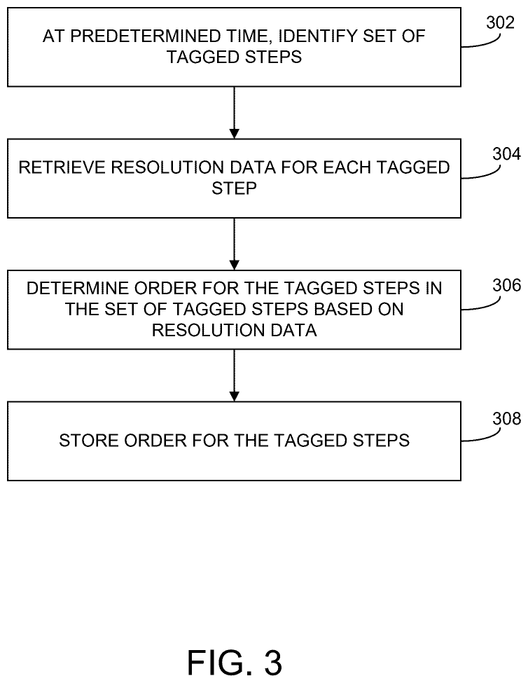

FIG. 3 illustrates a method for automatically determining an order of troubleshooting steps for a communication network in accordance with an embodiment. The process illustrated in FIG. 3 is described as being carried out by the system in FIG. 2. However, in some examples, the process of FIG. 3 may be implemented by a different system. Although the blocks of the process are illustrated in a particular order, in some embodiments, one or more blocks may be executed in a different order than illustrated in FIG. 3, or may be bypassed.

At block 302, at a predetermined time, a set of tagged steps for a troubleshooting flow can be identified using, for example, the troubleshooting module 202. In some embodiments a set of tagged troubleshooting steps can be identified for each of a plurality of troubleshooting flows. As mentioned above, the predetermined time can determine how frequently an order for the tagged steps for the troubleshooting flow (or each troubleshooting flow) is determined (or updated), for example, In some embodiments, once an hour, once a day, once a week, or continuously (e.g., each time a user starts a session with the troubleshooting module 202). At block 304, the troubleshooting module can retrieve resolution data for each tagged step from a database (e.g., tagged step and resolution database 204). In some embodiments, the resolution data for each tagged step can be retrieved for a predetermined time interval (or time frame), for example, the previous 24 hours, the past week, etc. As mentioned above, the resolution data can include, for example, a number of resolutions (or resolution volume) for each tagged step or a resolution rate (or percentage) for each tagged step.

At block 306, the troubleshooting module 202 can determine an order for each tagged step in the set of tagged steps based on the resolution data for each tagged step. In some embodiments, additional data, for example, an indication that there is a network outage, weather data or other data that may indicate conditions that impact network performance, can also be provided to the troubleshooting module 202 (e.g., from data storage 206). The additional data can be used to, for example, determine the order of tagged steps or determine the frequency of updates of the order of tagged steps (e.g., the predetermined time) or the predetermined time interval or time frame for the retrieved resolution data for each tagged step (e.g., previous 24 hours. In some embodiments, the order of tagged steps can be, for example, from highest number of resolutions within the predetermined time interval to lowest number of resolutions within the predetermined time interval or highest resolution rate to lowest resolution rate. In embodiments where the troubleshooting module 202 includes a plurality of troubleshooting flows, the troubleshooting module 202 can determine an order for the set of tagged steps associated with each troubleshooting flow at the predetermined time. At block 308, the order determined for the set of tagged steps for one or more troubleshooting flows can be stored in data storage 206.

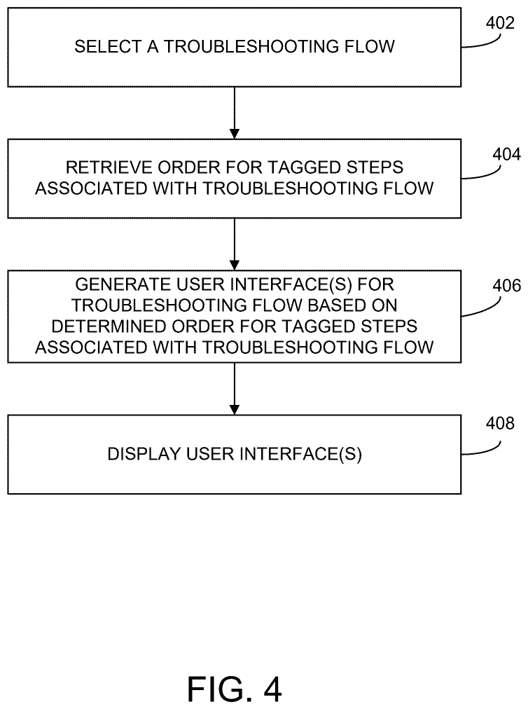

As mentioned above, the troubleshooting module 202 can utilize the determined order for the set of tagged steps for a troubleshooting flow to generate a graphical user interface to provide the troubleshooting steps to a user (e.g., a customer service representative of the CSP). FIG. 4 illustrates a method for generating user interface(s) for troubleshooting for a communication network in accordance with an embodiment. The process illustrated in FIG. 4 is described as being carried out by the system in FIG. 2. However, in some examples, the process of FIG. 4 may be implemented by a different system. Although the blocks of the process are illustrated in a particular order, in some embodiments, one or more blocks may be executed in a different order than illustrated in FIG. 4, or may be bypassed.

At block 402, a troubleshooting module 202 can select a troubleshooting flow. In some embodiments a user can start a session of the troubleshooting module 202 or enter other inputs, for example, using a user interface 216, 218, 220 of a user device 210, 212, 214 such as a computer system (e.g., computer system 600 shown in FIG. 6). In response to the start of a session or other inputs provided by a user (e.g., entering the issue, selecting an answer to an untagged question, etc.) the troubleshooting module can select an appropriate troubleshooting flow. At block 404, an order for a set of tagged steps associated with the selected troubleshooting flow can be retrieved, for example, from data storage 206. At block 406, the troubleshooting module 202 can then generate one or more user interfaces (e.g., a graphical user interface) that includes the set of tagged steps for the troubleshooting flow in the order determined based on the resolution data for each tagged step. For example, the tagged steps can be presented in the user interface(s) in an order from the highest number of resolutions to lowest number of resolutions or highest resolution rate to lowest resolution rate. At block 408, the generated user interface(s) can be displayed on a display (e.g., display 604 of computer system 600 shown in FIG. 6).

FIGS. 5A-5C illustrate an example graphical user interface for troubleshooting for a communication network in accordance with an embodiment. In the example of FIGS. 5A-5C, the selected troubleshooting flow is a general troubleshooting flow that includes one untagged step, namely, “Is the caller an employee of the CSP?” The example troubleshooting flow also has an associated set of three tagged steps including 1) “Is country customer in supported?”; 2) Is customer device compatible with their network?”; and 3) “Does the ICCID (Integrated Circuit Card Identification) and IMEI (International Mobile Equipment Identity) on device match what is on customer account” In this example the first tagged step has a resolution volume of 3 resolutions for the predetermined time interval (e.g., 24 hours), the second tagged step has a resolution volume of 12 resolutions for the predetermined time interval, and the third tagged step has a resolution volume of 30 resolutions in the predetermined time interval). As described above, at a predetermined time, an order for the tagged steps can be determined based on the resolution data (e.g., resolution volume) for each tagged step. In this example, the three tagged steps can be presented in a graphical user interface (GUI) in an order from highest resolution volume to lowest resolution volume.

In FIG. 5A, a GUI 502 can be generated that includes the untagged step 504 and a response (or answer) 506 entered by the user. In addition, the third tagged step 508 is presented to the user first along with inputs 510, 512 that can be selected for a “Yes” or “No” answer, respectively. For the third tagged step 508, a “No” 512 answer is a resolution and the troubleshooting flow ends. The resolution can be added to the resolution volume for the third tagged step and stored in a database (e.g., the tagged steps and resolution data database 204 shown in FIG. 2). If the user enters an answer of “Yes” 510, the troubleshooting flow can continue as shown in FIG. 5B. In FIG. 5B, a GUI 514 can be generated that presents the second tagged step 518 (with the second highest resolution volume) along with inputs 520, 522 that can be selected for a “Yes” or “No” answer, respectively. For the second tagged step 518, a “No”522 answer is a resolution and the troubleshooting flow ends. The resolution can be added to the resolution volume for the second tagged step and stored in a database (e.g., the tagged steps and resolution data database 204 shown in FIG. 2). If the user enters an answer of “Yes” 520, the troubleshooting flow can continue as shown in FIG. 5C. In FIG. 5C, a GUI 524 can be generated that presents the first tagged step 518 (with the lowest resolution volume) along with inputs 530, 532 that can be selected for a “Yes” or “No” answer, respectively. For the second tagged step 528, a “No” 522 answer is a resolution and the troubleshooting flow ends. The resolution can be added to the resolution volume for the second tagged step and stored in a database (e.g., the tagged steps and resolution data database 204 shown in FIG. 2). If the user enters an answer of “Yes” 520, the troubleshooting flow can, for example, return to a main page or continue with a different troubleshooting flow.

As mentioned above, various components of the disclosed system and method may be implemented on a computer system. FIG. 6 is a schematic block diagram of an example computer system in accordance with an embodiment. The computer system 600 (e.g., a server) may include one or more processor devices 602, a display 604, one or more inputs 606, one or more communication systems 608, and memory 610. In some embodiments, processor device(s) 602 can be any suitable hardware processor or combination of processors, such as a central processing unit (CPU), a graphics processing unit (GPU), a microprocessor, an application specific integrated circuit (ASIC), field programmable gate arrays (FPGA), digital signal processors (DSPs), etc. The processor device(s) 602 may include one or more processors, processor cores, processing elements, processor clusters, or other electronic processing units. Accordingly, a processing function described as being performed by the processor device(s) 602 may include multiple processors, processor cores, processing elements, processing clusters, etc. (of the processor device(s) 602) performing aspects or portions (sub-functions) of the processing function to complete the processing function. The one or more electronic processing units of the processor device(s) 602 may include one or more microprocessors, application-specific integrated circuits (“ASICs”), or other suitable electronic device for processing data. At least in some examples, the one or more electronic processing units of the processor device(s) 602 can be co-located physically (e.g., in the same facility, building, room, rack, or computing housing) as part of the computer system 600.

In some embodiments, display 604 can include any suitable display devices, such as a computer monitor, a touchscreen, a television, etc. In some embodiments, display 604 can be omitted. In some embodiments, inputs 606 can include any suitable input devices and/or sensors that can be used to receive user input, such as a keyboard, a mouse, a touchscreen, a microphone, a graphical user interface (GUI), a voice user interface (VOI), mechanical switches, buttons, knobs, etc. and allow a user or operator to interact with the system for automatically determining an order of troubleshooting steps for a communication network. In some embodiments, inputs 606 can be omitted.

In some embodiments, communications system(s) 608 can include any suitable hardware, firmware, and/or software for communicating information over any suitable communication network (e.g., communication network 100 shown in FIG. 1). For example, communication system(s) 608 can include one or more transceivers, one or more communication chips and/or chip sets, etc. In a more particular example, communication system(s) 608 can include hardware, firmware and/or software that can be used to establish a Wi-Fi connection, a Bluetooth connection, a cellular connection. an Ethernet connection, etc.

In some embodiments, memory 610 can include any suitable storage device or devices (e.g., one or more non-transitory computer readable media) that can be used to store instructions, values, etc., that can be used, for example, by processor device 602 to present content using display 604, to communicate with a communication network, to communicate with other computer systems, etc. Memory 610 can include any suitable volatile memory, non-volatile memory, storage, or any suitable combination thereof. For example, memory 610 can include RAM, ROM, EEPROM, one or more flash drives, one or more hard disks, one or more solid state drives, one or more optical drives, etc. The memory 610 may store data and/or instructions for use and execution by the computer system 600 (e.g., by the processor device(s) 602) to implement the functionality of, for example, a troubleshooting module, a tagged steps and resolution database, data storage, graphical user interfaces, etc. described herein. For example, the memory 610 may include or store the troubleshooting module 202, a tagged steps and resolution database 204, and data storage 206 shown in FIG. 2. In some embodiments, the functionality described herein as being performed by the computer system 600 may be distributed among multiple computer systems, servers or devices (e.g., as part of a cloud service or cloud-computing environment).

In some examples, aspects of the technology, including computerized implementations of methods according to the technology, can be implemented as a system, method, apparatus, or article of manufacture using standard programming or engineering techniques to produce software, firmware, hardware, or any combination thereof to control a processor device (e.g., a serial or parallel general purpose or specialized processor chip, a single-or multi-core chip, a microprocessor, a field programmable gate array, any variety of combinations of a control unit, arithmetic logic unit, and processor register, and so on), a computer (e.g., a processor device operatively coupled to a memory), or another electronically operated controller to implement aspects detailed herein. Accordingly, for example, examples of the technology can be implemented as a set of instructions, tangibly embodies on a non-transitory computer-readable media, such that a processor device can implement the instructions based upon reading the instructions from the computer-readable media. Some examples of the technology can include (or utilize) a control device such as an automation device, a special purpose or general-purpose computer including various computer hardware, software, firmware, and so on. As specific examples, a control device can include a processor, a microcontroller, a field-programmable gate array, a programmable logic controller, logic gates, etc., and other types of components that are known in the art for implementation of appropriate functionality (e.g., memory, communication systems, power sources, user interfaces, and other inputs, etc.).

Certain operations of the methods according to the technology, or of systems executing those methods, can be represented schematically in the FIGs. or otherwise discussed herein. Unless otherwise specified or limited, representation in the FIGs. of particular operations in particular spatial order can not necessarily require those operations to be executed in a particular sequence corresponding to the particular spatial order. Correspondingly, certain operations represented in the FIGs., or otherwise disclosed herein, can be executed in different orders than are expressly illustrated, as appropriate for particular examples of the technology. Further, in some examples, certain operations can be executed in parallel, including by dedicated parallel processing devices, or separate computing devices configured to interoperate as part of a large system.

The present technology has been described in terms of one or more preferred embodiments, and it should be appreciated that many equivalents, alternatives, variations, and modifications, aside from those expressly stated, are possible and within the scope of the invention.

1. A system for automatically determining an order of troubleshooting steps for a communication network, the system comprising:
a memory that stored one or more computer readable media that includes instructions; and
one or more processor devices configured to execute the instructions of the computer readable media to:
identify a set of tagged steps for a troubleshooting flow at a predetermined time;
retrieve resolution data for each tagged step from a database, the resolution data from a predetermined time interval;
determine an order for the tagged steps in the set of tagged steps based on the resolution data for each tagged step; and
store the order for the tagged steps in data storage.

2. The system according to claim 1, wherein the one or more processor devices are configured to further execute the instructions of the computer readable media to generate one or more graphical user interfaces including the set of tagged steps in the determined order.

3. The system according to claim 2, wherein the one or more processor devices are configured to further execute the instructions of the computer readable media to display the one or more graphical user interfaces on a display.

4. The system according to claim 1, wherein the resolution data for each tagged step comprises a number of resolutions.

5. The system according to claim 1, wherein each tagged step is in the form of a question.

6. The system according to claim 1, wherein the troubleshooting flow is associated with one or more of a type of problem, a type of user equipment device, a type of communication service, or a type of error code.

7. The system according to claim 1, wherein the troubleshooting flow further comprises at least one untagged step.

8. A method for automatically determining an order of troubleshooting steps for a communication network, the method comprising:
identifying, using a processor device, a set of tagged steps for a troubleshooting flow at a predetermined time;
retrieving, using the processor device, resolution data for each tagged step from a database, the resolution data from a predetermined time interval;
determining, using the processor device, an order for the tagged steps in the set of tagged steps based on the resolution data for each tagged step; and
storing the order for the tagged steps in data storage.

9. The method according to claim 8, further comprising generating one or more graphical user interfaces including the set of tagged steps in the determined order.

10. The method according to claim 9, further comprising displaying the one or more graphical user interfaces on a display.

11. The method according to claim 8, wherein the resolution data for each tagged step comprises a number of resolutions.

12. The method according to claim 8, wherein each tagged step is in the form of a question.

13. The method according to claim 8, wherein the troubleshooting flow is associated with one or more of a type of problem, a type of user equipment device, a type of communication service, or a type of error code.

14, The method according to claim 8, wherein the troubleshooting flow further comprises at least one untagged step.

15. A non-transitory, computer-readable medium storing instructions that, when executed by a processor perform a set of functions for automatically determining an order of troubleshooting steps for a communication network, the set of functions comprising:
identifying, using a processor device, a set of tagged steps for a troubleshooting flow at a predetermined time;
retrieving, using the processor device, resolution data for each tagged step from a database, the resolution data from a predetermined time interval;
determining, using the processor device, an order for the tagged steps in the set of tagged steps based on the resolution data for each tagged step; and
storing the order for the tagged steps in data storage.

16. The non-transitory computer-readable medium according to claim 15, wherein the set of functions further comprises generating one or more graphical user interfaces including the set of tagged steps in the determined order.

17. The non-transitory computer-readable medium according to claim 16, wherein the set of functions further comprises displaying the one or more graphical user interfaces on a display.

18. The non-transitory computer-readable medium according to claim 15, wherein the resolution data for each tagged step comprises a number of resolutions.

19. The non-transitory computer-readable medium according to claim 15, wherein each tagged step is in the form of a question.

20. The non-transitory computer-readable medium according to claim 15, wherein the troubleshooting flow further comprises at least one untagged step.
